(19) United States
(12) Patent Application Publication
(10) Pub. No.: US 2016/0040597 A1
(43) Pub. Date: Feb. 11, 2016

(54) METHOD FOR REDUCING THE CO EMISSIONS OF A GAS TURBINE, AND GAS TURBINE

(71) Applicant: SIEMENS AKTIENGESELLSCHAFT, München (DE)

(72) Inventor: Nicolas Savilius, Essen (DE)

(73) Assignee: Siemens Aktiengesellschaft, Munich (DE)

(21) Appl. No.: 14/782,827

(22) PCT Filed: Feb. 27, 2014
(86) PCT No.: PCT/EP2014/053821

§ 371 Date: Oct. 7, 2015

(30) Foreign Application Priority Data
Apr. 12, 2013 (EP) 13163532.8

(51) Int. Cl. F02C 7/10; F02C 3/04

(52) U.S. Cl. CPC F02C 7/10; F02C 3/04; F05D 2220/32; F05D 2270/303; F05D 2270/08

(57) ABSTRACT

A method for reducing the CO emissions of a gas turbine having a compressor, a turbine and an air preheater positioned upstream of the compressor, that permits technically simpler regulation without losses in terms of the quality of the reduction of the CO emissions. The heat transfer power of the air preheater is regulated on the basis of a minimum value for the inlet temperature of the compressor, wherein the minimum value is predefined as a function of the absolute power of the gas turbine.

### CROSS REFERENCE TO RELATED APPLICATIONS

This application is the US National Stage of International Application No. PCT/EP2014/053821 filed Feb. 27, 2014, and claims the benefit thereof. The International Application claims the benefit of European Application No. EP13163532 filed Apr. 12, 2013. All of the applications are incorporated by reference herein in their entirety.

### FIELD OF INVENTION

The invention relates to a method for reducing the CO emissions of a gas turbine having a compressor, a turbine and an air preheater connected upstream from the compressor. It also relates to a gas turbine having a compressor, a turbine, an air preheater connected upstream from the compressor, a temperature measurement device, arranged between the compressor and the air preheater, which is connected on the data output side to a control device of the gas turbine, a capacity measurement device which is connected on the data output side to the control device, and means for regulating the heat transfer capacity of the air preheater which are connected on the control input side to the control device.

### BACKGROUND OF INVENTION

Stationary gas turbines are often used in power plants to generate electricity. Gas turbine power plants can be used very flexibly in the power grid as they offer the possibility of quick changes in load. At these times when there is an expansion in sources of renewable energy which generate energy only irregularly depending on the strength of the wind and the amount of solar radiation, by virtue of their flexibility gas turbine power plants offer the possibility of compensating for these fluctuations in capacity.

It is, however, hereby undesirable to shut the gas turbine down when capacity is not required and start it up again because on the one hand this is unfavorable in terms of energy and on the other hand it generates high mechanical loads on the components of the gas turbine owing to the fluctuations in temperature which occur. This reduces their lifetime. Last but not least, it takes a certain amount of time to start the gas turbine up so that the reaction time when capacity is requested from the power grid is reduced. It is therefore desirable, when capacity is not required, to continue to operate the gas turbine at the lowest possible capacity in partial load mode.

However, the minimum possible capacity is here often required not because of technical circumstances but instead because of legal stipulations with regard to the limits for carbon monoxide (CO) emissions in the exhaust gas. When capacity falls, the combustion temperature in the combustion chamber falls so that combustion takes place only incompletely and the development of CO is promoted.

To remedy this situation, air preheaters are often used which are arranged at the inlet of the compressor. With their aid the compression inlet temperature is increased, as a result of which the combustion temperature is ultimately increased and the CO content of the exhaust gas thus falls. Corresponding means for regulating the heat transfer capacity, which are connected on the control input side to a control device of the gas turbine, are provided for regulating the air preheater.

The regulation of the air preheater and its heat transfer capacity is usually relatively complex as the CO emissions are typically a function of the relative capacity of the gas turbine: the start-up and shutdown point of the air preheater are thus defined with the aid of the relative capacity of the gas turbine, i.e. with regard to its maximum possible capacity. The maximum possible capacity here depends on the current external temperature so that a measurement device for the external temperature must be provided. If the air preheater is switched on, an increase in temperature is usually predetermined which must be effected by said air preheater, i.e. a further temperature measurement device, which determines the difference in temperature before and after the sucked-in air has passed through the air preheater, is arranged between the compressor and the air preheater. A target value, by means of which the heat transfer capacity of the air preheater is regulated, is predetermined for this difference in temperature. The target value is here typically in turn dependent on the external temperature.

The regulation of the air preheater in total is thus very complex. Calculating the current relative capacity in order to determine the switching-on and switching-off points alone requires a certain degree of calculation complexity, as does determining via the air preheater the current difference in temperature which is to be obtained.

### SUMMARY OF INVENTION

An object of the invention is therefore to provide a method for reducing the CO emissions of a gas turbine, and a gas turbine, which allow simpler technical regulation without any decline in the quality of the reduction of the CO emissions.

According to aspects of the invention, this object is achieved in terms of the method by the heat transfer capacity of the air preheater being regulated with the aid of a minimum value for the inlet temperature of the compressor, and wherein the minimum value is predetermined as a function of the absolute capacity of the gas turbine.

The invention here starts from the consideration that technical regulation could be simplified in particular by the dependence on the current external temperature being removed. To achieve this, a fixed minimum value for the compressor inlet temperature should initially be predetermined which is not dependent on the external temperature. Moreover, the previous switching-on and switching-off points which were dependent on the relative capacity of the gas turbine should also no longer be necessary. In addition, the dependence of the regulation on the relative capacity of the gas turbine must in general cease to apply because the maximum capacity on the basis of which the relative capacity is calculated as a percentage likewise depends on the external temperature. The minimum value for the compressor inlet temperature should therefore only be predetermined depending on the absolute capacity of the gas turbine. It has hereby surprisingly proven to be the case that air preheating regulated in this way, which is technically considerably more simple to achieve, is at least on a par with the previous complex regulation, both in terms of the efficiency of the gas turbine and also in terms of the efficiency of the CO reduction.

In an advantageous embodiment of the method, the function is determined with the aid of a model calculation for the gas turbine. The dependence of the minimum value for the compressor inlet temperature on the absolute capacity of the gas turbine is thus determined on a theoretical basis specifically for a specific gas turbine. This can be performed using corresponding thermodynamics data processing programs. The function is here aligned with both the technical circumstances of the respective gas turbine plant and the legal stipulations with regard to CO emissions at the locations where they are installed. Corresponding safety measures are hereby also advantageously incorporated in order to ensure CO-compliant operation at all times.

The function is here advantageously monotonously decreasing, i.e. lower minimum values for the compressor inlet temperature are also predetermined for higher absolute capacity values. As a result, it is ensured that the air entering the compressor is preheated in partial load mode, i.e. when the absolute capacity is lower. It is particularly when the capacity is low that the CO emissions do indeed increase owing to the falling combustion temperature in the combustion chamber of the gas turbine.

In a further advantageous embodiment, the function is constant below a lower threshold value and/or above an upper threshold value for the capacity of the gas turbine. Indeed because the air preheating in turn influences the capacity of the gas turbine, feedback effects in these areas are avoided. The regulation is thereby stabilized.

The function also advantageously runs linearly between the threshold values. This too increases the stability of the regulation during the operation of the gas turbine.

Below the lower threshold value, the function advantageously has a value of approximately 20° to 50° C., and/or above the upper threshold value, it advantageously has a value of approximately −20° C. As a result, when the capacity of the gas turbine is above the upper threshold value and the external temperature is sufficient, the switching-off of the system is initiated. When the capacity is low, a minimum value of 20° C. to 50° C. is sufficient to obtain the desired reduction of the CO emissions.

The CO emissions are advantageously reduced in a gas turbine using the method described.

The object is achieved in terms of the gas turbine by a function being stored in the control device which predetermines a minimum value for the inlet temperature of the compressor depending on the absolute capacity of the gas turbine.

In an advantageous embodiment, the air preheater comprises a heat exchanger. The latter enables heat to be transferred particularly effectively and readily controllably into the air which enters the compressor and additionally leaves without any mass transfer. As a result, the heat exchanger is sealed off from the airflow so that an optimal heat conduction medium can be used inside the circuit of the heat exchanger, for example a water/glycol mixture. The heat exchanger can hereby be designed as a tube grid upstream from the inlet of the compressor.

A power plant advantageously comprises a gas turbine as described.

The power plant is here advantageously designed as a gas-and-steam turbine plant and thus comprises a steam turbine. The exhaust gas of the gas turbine is here conducted through a steam generator, the steam generated by the latter being used to drive the steam turbine. The thermal energy of the exhaust gas is thus used, which considerably increases the efficiency of the whole plant.

In an advantageous embodiment, the heat exchanger is here part of a heat circuit with a heat exchanger in that part of the power plant which is associated with the steam turbine. In other words, the heat energy for preheating the air flowing into the compressor is removed in the steam turbine, for example in the low-pressure region. As a result, the efficiency of the whole plant is optimized when the air preheating is switched on.

The advantages obtained with the invention include in particular the fact that, by virtue of predetermining a minimum value for the inlet temperature that is dependent only on the absolute capacity of the gas turbine, it is made possible to regulate the air preheater technically much more simply. There is no longer any need for a separate switching-on and switching-off limit of the regulation. Likewise, the external temperature is no longer required for the regulation, which reduces the complexity of the measurement technology required. The control system technology of the gas turbine can likewise be simplified because only the absolute gas turbine capacity is required as an input value, which is typically present in any case as a measurement value. The required function can specifically be established quickly for the respective gas turbine and also enables more accurate operation than the previous method.

### BRIEF DESCRIPTION OF THE DRAWINGS

The invention is explained in detail with the aid of an exemplary embodiment shown in the drawings, in which:

FIG. 1 shows a gas turbine schematically in a gas-and-steam power plant,

FIG. 2 shows a function graph of the CO emissions plotted against the relative gas turbine capacity, and

FIG. 3 shows a function graph of a minimum value for the inlet temperature of the compressor plotted against the absolute gas turbine capacity.

### DETAILED DESCRIPTION OF INVENTION

The same parts are provided in all the drawings with the same reference numerals.

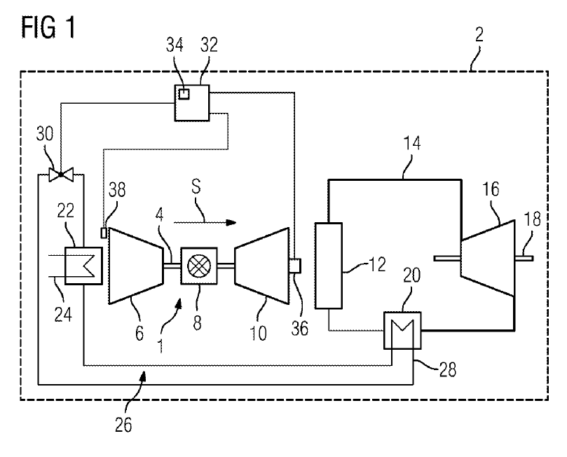

A gas turbine 1 in a gas-and-steam turbine power plant 2 is shown schematically in FIG. 1. A gas turbine 1 is a fluid-flow machine in which a pressurized gas expands. It comprises a compressor 6, a combustion chamber 8, and a turbine 10, on a shaft 4 forming an axis in the direction of flow S of the gas.

The operating principle is based on the Brayton cycle: air is sucked in at the inlet of the compressor 6, compressed and mixed with a fuel and ignited in the combustion chamber 8. The hot gas mixture is then depressurized in the turbine 10 and leaves as exhaust gas at the outlet of the turbine 10. Thermal energy is converted into mechanical energy in the turbine and initially drives the compressor 6. The remaining part is used to drive a generator (not shown in detail).

In the gas-and-steam power plant 2 shown in FIG. 1, the exhaust gas of the turbine 1 is conducted into a steam generator 12 and the steam generated there is used, via a steam pipe 14, to drive a steam turbine 16. The steam turbine 16 is arranged in FIG. 1 on a separate shaft 18 but can also be arranged on the same shaft 4 as the gas turbine 1. The depressurized steam from the steam turbine 16 is conducted into a condenser 20 and passed on from there to the steam generator 12.

Both the compressor 6 and the turbine 10 of the gas turbine 1 and steam turbine 16 have guide blades and rotor blades (not shown in detail) arranged alternately inside a casing in an axial direction. The guide blades are arranged along the circumference of the respective shaft 4, 18, forming a circle. Such a circle of guide blades is also referred to as a guide blade wheel. The rotor blades are also arranged annularly in rotating fashion as a rotor blade wheel on the respective shaft 4, 18.

A guide blade wheel, together with the upstream or downstream rotor blade wheel, is referred to as a compressor or turbine stage.

An air preheater 22 is arranged upstream from the inlet of the compressor 6. It comprises a heat exchanger 24 which is formed from pipes arranged in a grid. The pipes are designed for optimum heat input into the inlet mass flow of air into the compressor 6. The heat exchanger 24 is thus part of a heat circuit 26 with a further heat exchanger 28 in the condenser 20 and a flow control valve 30 by means of which the circulation of a water/glycol mixture in the heat circuit 26 can be regulated.

The flow control valve 30 is connected, on the control inlet side, to a control device 32 which can regulate the flow in the heat circuit 26 and hence the discharge of heat to the air upstream from the compressor 6. The control device 32 has a memory 34.

The air preheater 22 is used to heat the air which can be sucked in by the compressor 6 in order thus to keep the CO content in the exhaust gas of the gas turbine 1 below the legally stipulated limits. In order to do this, the control device 32 is connected, on the data input side, to a capacity measurement device 36 for the capacity of the gas turbine and to a temperature measurement device 38 between the air preheater 22 and the compressor 6.

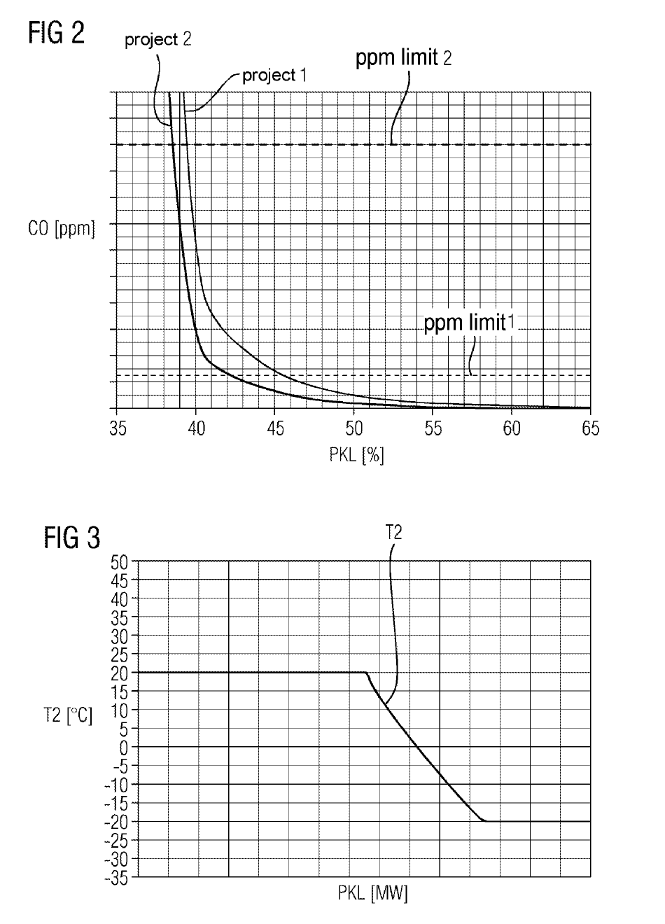

FIG. 2 shows a graph which illustrates the functional dependence of the CO content in the exhaust gas of the gas turbine 1. The CO content in parts per million (ppm) is plotted against the relative capacity of the gas turbine (PKL) in percent. No absolute values are given here for the CO content because the latter depends on the specific respective gas turbine 1. 100% corresponds here to the capacity of the gas turbine 1 at full load. This full load capacity is, however, dependent on the external temperature.

FIG. 2 shows, by way of example, two legal limit values (ppm limit 1, ppm limit 2), not defined in more detail, which can exist depending on the legislation in force at the location of the gas-and-steam power plant 2. The curves in turn show, by way of example, two different values for the CO content in the exhaust gas for two different gas-and-steam power plants (project 1, project 2).

The minimum value is determined in the control device 32, with the aid of a function saved in the memory 34 and shown in FIG. 3, solely from the absolute capacity of the gas turbine 1. The function was determined for the gas turbine 1 specifically in advance with the aid of theoretical model calculations of a thermodynamic type. The current absolute gas turbine capacity is made available to the control device 32 by the capacity measurement device 36 so that a minimum value is present at all times for the inlet temperature at the compressor 6.

FIG. 3 shows the function, namely the minimum value for the compressor inlet temperature (T2) in degrees Celsius plotted against the absolute gas turbine capacity in megawatts (MW). Because the function is here too determined only by way of example for a specific gas turbine 1, no actual values have been given for the absolute capacity. In a first range up to a first limit value, the curve is constant at 20° C. Alternatively, higher values such as, for example, up to 50° C. are possible. In a second range from a higher second limit value up to the maximum capacity of the gas turbine 1, it is also constant at −20° C. Between the said limit values, the curve is essentially linear. The curve is here absolutely constantly and monotonously decreasing.

As long as the compressor inlet temperature T2 detected by the temperature measurement device 38 is below the minimum value, associated with the capacity which currently needs to be supplied by the gas turbine 1, for the compressor inlet temperature T2, the control device 32 regulates the air preheater 22 and thus the heat input into the air flowing into the compressor 6 via the flow control valve 30. As long as the compressor inlet temperature T2 is below the minimum value, the continuously supplied input of heat increases by the flow control valve 30 being opened more, until the compressor inlet temperature T2 reaches the minimum value. This prevents the occurrence of unacceptably high emissions in the exhaust gas. As long as the compressor inlet temperature T2 is above the minimum value even without the air preheater 22 being activated, the flow control valve 30 remains completely closed.

The CO content in the exhaust gas of the gas turbine 1 is reduced using control technology in a particularly simple manner by the air preheater 22 being regulated with the aid of a minimum value for the compressor inlet temperature which is fixed only depending on the absolute gas turbine capacity.

1. A method for reducing the CO emissions of a gas turbine having a compressor, a turbine and an air preheater connected upstream from the compressor, the method comprising:
regulating a heat transfer capacity of the air preheater with the aid of a minimum value for the inlet temperature of the compressor, and
predetermining the minimum value as a function of an absolute capacity of the gas turbine.

2. The method as claimed in claim 1,
wherein the function is determined with the aid of a model calculation for the gas turbine.

3. The method as claimed in claim 1,
wherein the function is monotonously decreasing.

4. The method as claimed in claim 1,
wherein the function is constant below a lower limit value and/or above an upper limit value for the capacity of the gas turbine.

5. The method as claimed in claim 4,
wherein the function is linear between the limit values.

6. The method as claimed in claim 4,
wherein the function has a value of approximately 20° C. below the lower limit value and has a value of approximately 20° C. above the upper limit value.

7. A gas turbine comprising
a compressor,
a turbine,
an air preheater connected upstream from the compressor,
a temperature measurement device, arranged between the compressor and the air preheater, which is connected on a data output side to a control device of the gas turbine,
a capacity measurement device which is connected on the data output side to the control device, and
a flow control valve for regulating the heat transfer capacity of the air preheater which is connected on the control input side to the control device,
wherein a function is stored in the control device which predetermines a minimum value for the inlet temperature of the compressor depending on the absolute capacity of the gas turbine.

8. The gas turbine as claimed in claim 7,
wherein the air preheater comprises a heat exchanger.

9. A power plant comprising
a gas turbine as claimed in claim 7.

10. The power plant as claimed in claim 9, comprising
a steam turbine.

11. The power plant as claimed in claim 10,
wherein the air preheater comprises a heat exchanger which is part of a heat circuit with a heat exchanger in that part of the power plant which is associated with the steam turbine.
